(19) United States
(12) Patent Application Publication
(10) Pub. No.: US 2022/0096303 A1
(43) Pub. Date: Mar. 31, 2022

(54) INFLATABLE HYPERBARIC CHAMBER WITH A MULTILAYER STRUCTURE

(71) Applicants: Peter KOKALJ, Kranj (SI); Tina KOKALJ, Kranj (SI)

(72) Inventors: Peter KOKALJ, Kranj (SI); Tina KOKALJ, Kranj (SI)

(21) Appl. No.: 17/428,772

(22) PCT Filed: Feb. 5, 2020
(86) PCT No.: PCT/SI2020/050003

§ 371 Date: Aug. 5, 2021

(30) Foreign Application Priority Data
Feb. 6, 2019 (SI) P-201900024

(51) Int. Cl. A61G 10/02

(52) U.S. Cl. CPC A61G 10/026

(57) ABSTRACT

The present invention belongs to the field of hyperbaric chambers for performing hyperbaric and hyperbaric-oxygen therapies for medical or non-medical purposes, more precisely to the field of constructional execution of flexible-inflatable hyperbaric chambers. The essence of the inflatable hyperbaric chamber with a multilayer structure according to the invention is in the three-layer structure and in separable connection of individual layers of the said structure as well as functional elements, which allows the chamber to operate at a pressures between 130 kPa (1.3 bar) and 300 kPa (3.0 bar). The three-layer structure consists of an inner bag for sealing, an outer bag for protection and relief of the inner bag and which maintains the shape of the chamber, as well as a grid for maintaining the structure and even distribution of forces.

### FIELD OF THE INVENTION

The present invention belongs to the field of hyperbaric chambers for performing hyperbaric and hyperbaric-oxygen therapies for medical or non-medical purposes, more precisely to the field of construction of flexible-inflatable hyperbaric chambers.

### THE TECHNICAL PROBLEM

Hyperbaric chambers are intended for hyperbaric therapies, which have positive effects on human body. The particular effect of hyperbaric therapies in combination with oxygen is already known, but the known chambers are complicated and consequently expensive. Hyperbaric chambers have to comply with different safety requirements, thus individual functional parts of hyperbaric chambers have to be properly constructed and designed to fulfil said requirements.

The technical problem is a constructional design of an inflatable transportable hyperbaric chamber (in continuation inflatable hyperbaric chamber) for therapeutic and regeneration purposes, that will allow pressures inside the chamber between 130 kPa (1.3 bar) and 300 kPa (3.0 bar). The components of the chamber have to allow folding of individual parts, so that assembly into the final shape is possible even without tools and accessories. Connections for the bags forming the chamber have to withstand the tension due to overpressure, and the best possible sealing of the joints must be ensured the weak part of the flexible inflatable chamber is a zipper for closing the entrance into the chamber, as it can be opened due to the overpressure. Further, all components of the chamber have to be fastened in a simple and reliable manner in order to ensure the patient safe conditions through the entire therapy inside the chamber.

The aim of the invention is thus a constructional design allowing controlled conditions inside the hyperbaric chamber, wherein pressure, oxygen pressure, humidity and temperature can be regulated.

### STATE OF THE ART

Hyperbaric chambers have been described in multitude of patents and patent applications, wherein the chambers have been designed in various manners.

U.S. Pat. No. 5,360,001 describes a hyperbaric chamber with oxygen supply, wherein the chamber is approximately cylindrically shaped and is made of a flexible, air impermeable material. This solution differs from the present invention in its frame and overall chamber design.

U.S. Pat. No. 5,678,543 discloses that a lightweight, transportable, inflatable and collapsible hyperbaric chamber is made of a flexible, foldable and non-slip material and has pressure-generating equipment with means for setting pressure inside the chamber as well as an outlet device of a differential pressure valve for reaching and maintaining air pressure inside the chamber. The chamber also has means for entering and leaving the chamber, which can be closed to prevent loss of air pressure. Said system enables air pressure inside the chamber around 0.2 to 22 psi higher than it is in the environment, while the entering and leaving means comprise at least one inner layer and at least one outer layer, wherein each layer closes with a zipper, and wherein one of the zippers is a mechanical zipper.

U.S. Pat. No. 5,738,093 describes a hyperbaric chamber comprising a flexible, air impermeable cell, which is equipped with one opening on one or on each end, an internal frame for maintaining the shape, an outer grid especially placed in one side wall of the cell. The invention has a flexible restraining cage in the shape of the outer grid, made from straight textile straps distributed in a number of radial hoops and in a number of longitudinal elements, wherein the cross-sections of the hoops and longitudinal elements is fixed in order to ensure consistent geometry of the said cage. The flexible cage is provided with a metal shield and metal collar. This solution differs from the present invention in that the flexible air impermeable material cell and the outer net are designed in a different manner as in this solution.

### DESCRIPTION OF THE SOLUTION OF THE TECHNICAL PROBLEM

The essence of the inflatable hyperbaric chamber with a multilayer structure according to the invention is in the three-layer structure and in a separable (releasable) connection of individual layers of the said structure as well as in functional elements, which allow operation of the chamber at pressures between 130 kPa (1.3 bar) and 300 kPa (3.0 bar). The three-layer structure comprises an inner bag for sealing, an outer bag for protection and relief of the inner bag as well as maintenance of the shape of the chamber, and a grid for maintaining the structure and uniform distribution of forces.

The inflatable hyperbaric chamber with the multi-layer structure according to the invention can thus achieve high working pressures due to:
a closing system provided with a reinforced pocket (flap) on the outer bag, the said flap covering and relieving the zipper on the inner bag and the grid provided with belts with buckles for additional protection of the zipper;
two strong rings on the chamber bottoms, which allow equal distribution of horizontal straps of the grid and additionally open two circular windows;
two strong specially designed windows on the side of the chamber; and
a special system of valves and instruments for controlling the pressure inside the chamber, wherein the said system connects the inner and the outer bag.

The inflatable hyperbaric chamber with a multi-layer structure according to the invention will be described in more detail based on an embodiments and figures, which show:

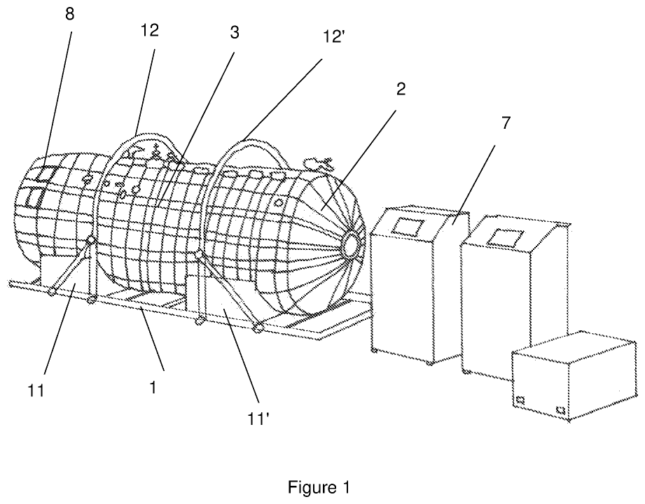

FIG. 1 Exterior of the chamber

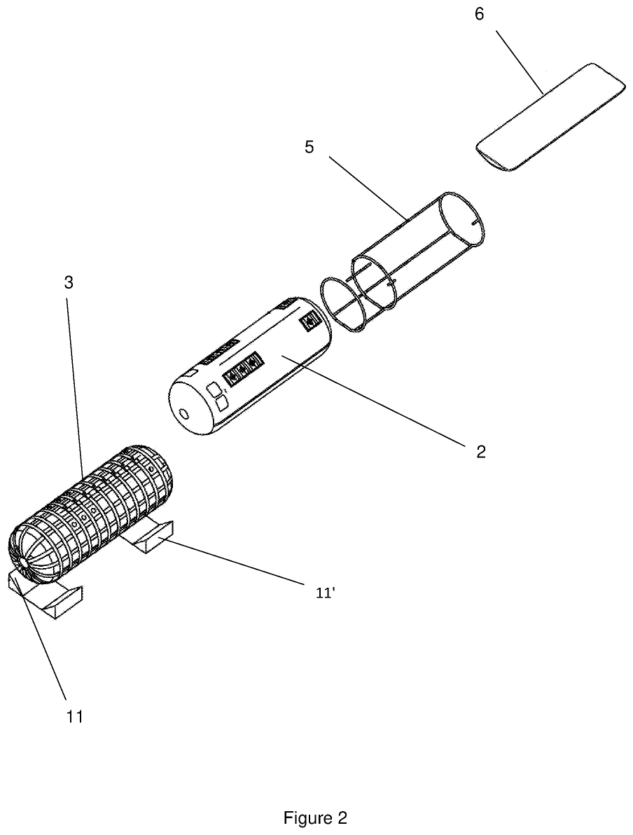

FIG. 2 chamber assembly

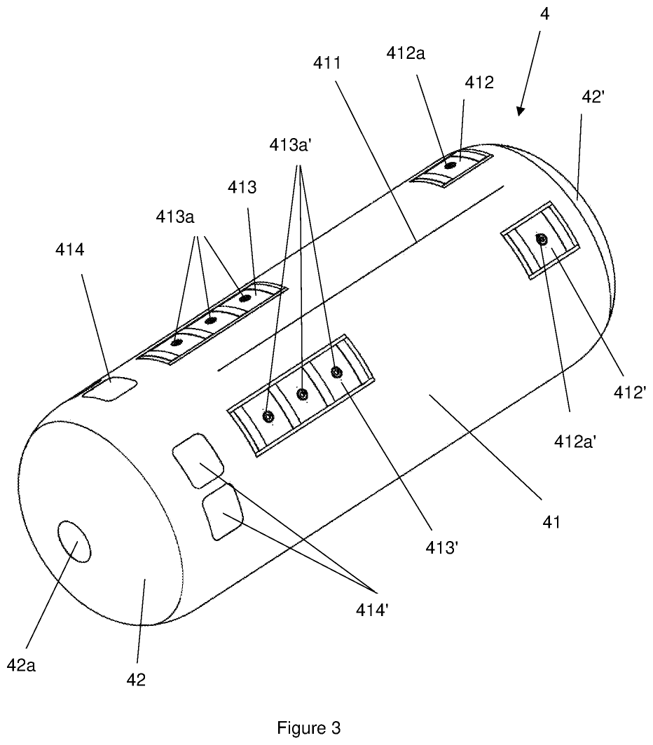

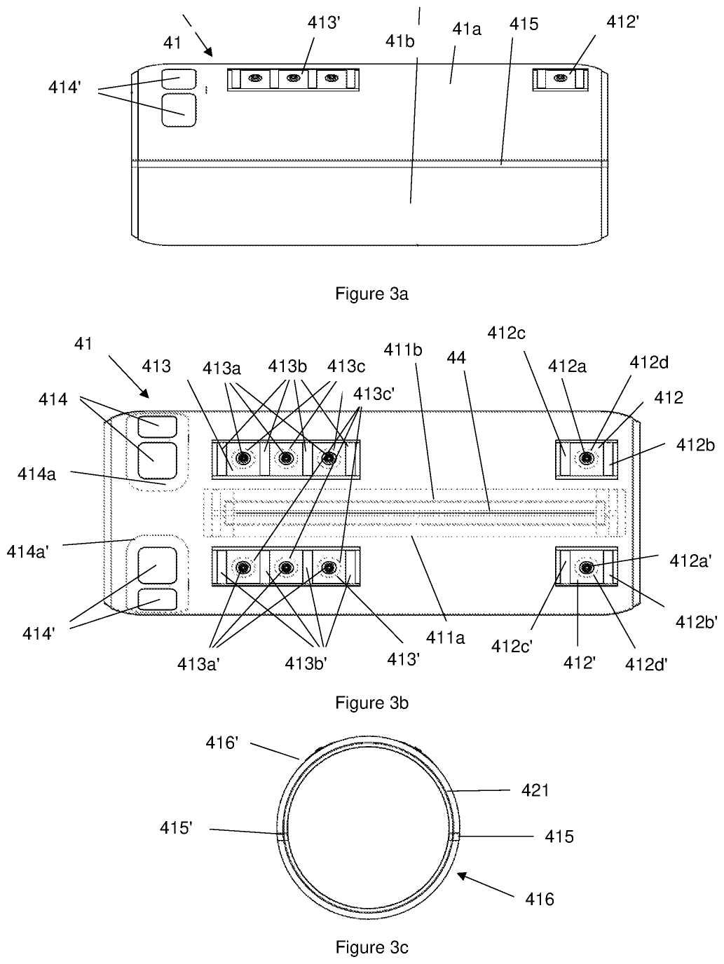

FIG. 3a outline of the inner bag

FIG. 3b inner bag layout

FIG. 3c side drawing of the inner bag

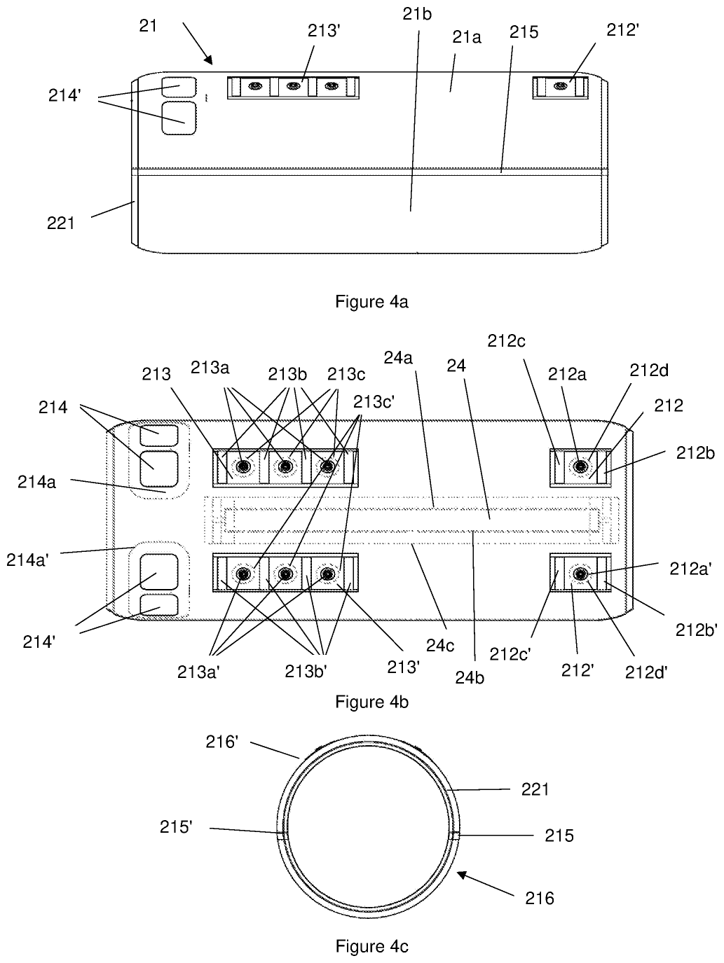

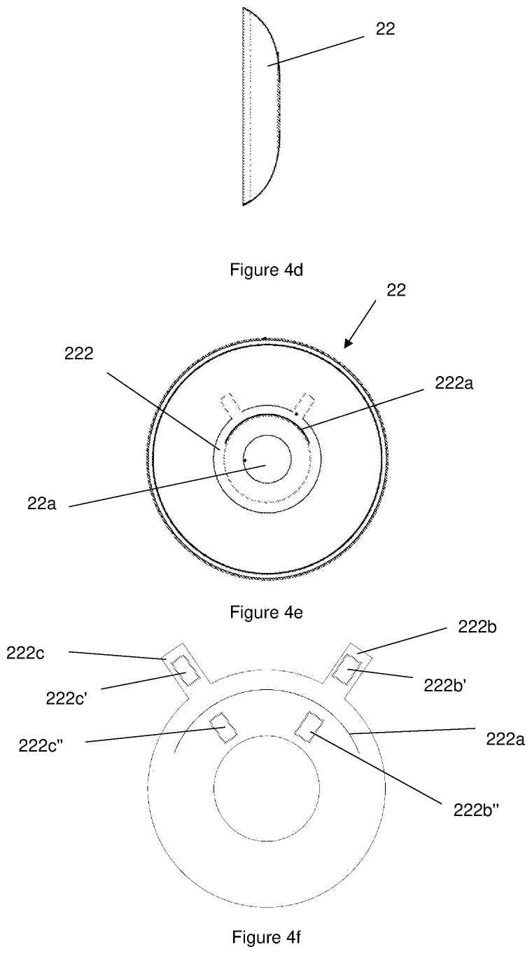

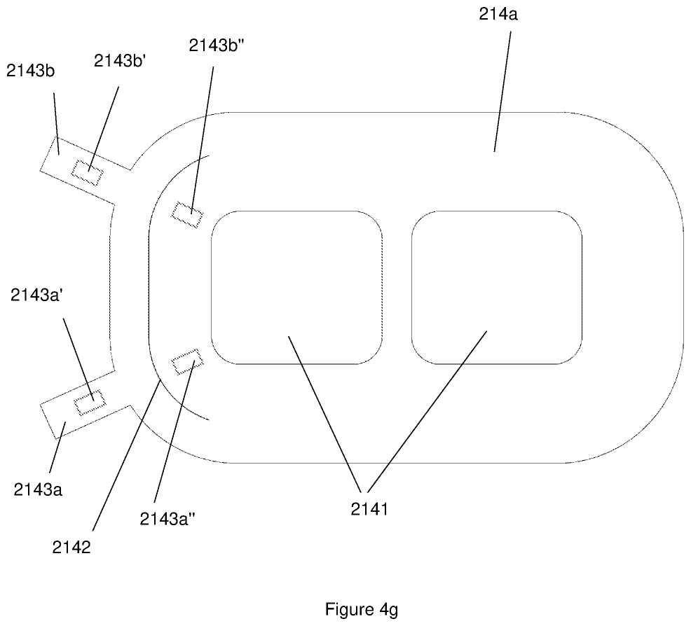

FIG. 4a outer bag layout

FIG. 4b outline of the outer bag

FIG. 4c side drawing of the outer bag

FIG. 4d outer appearance of the bottom 22

FIG. 4e side drawing of the bottom 22

FIG. 4f the holder of the circular window

FIG. 4g the holder of the rectangular window

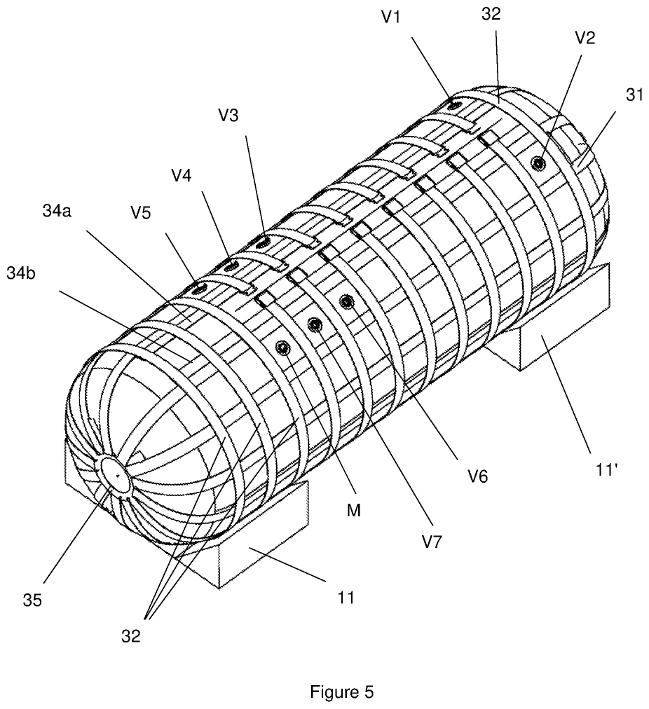

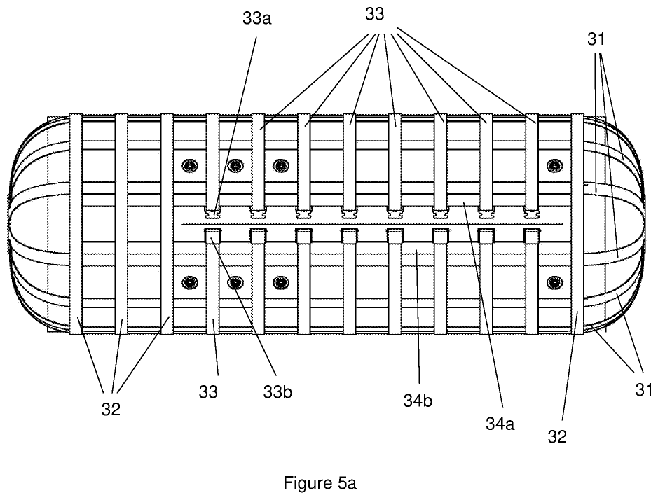

FIG. 5 grid 3

FIG. 5a grid 3 layout

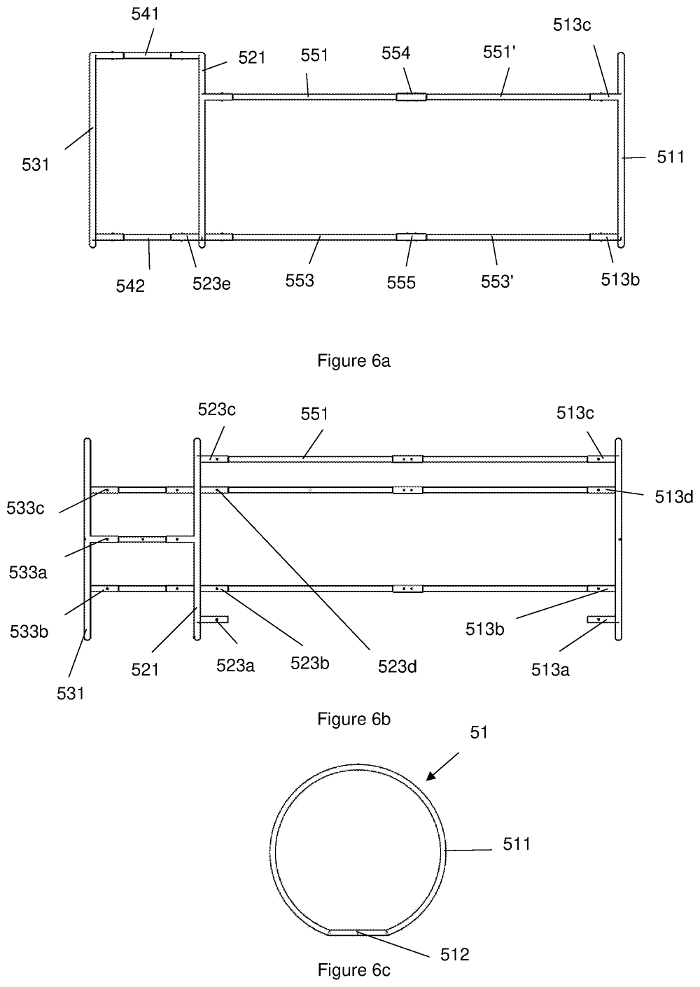

FIG. 6a outline of the internal frame 5

FIG. 6b internal frame 5 layout

FIG. 6c side drawing of the internal frame 5

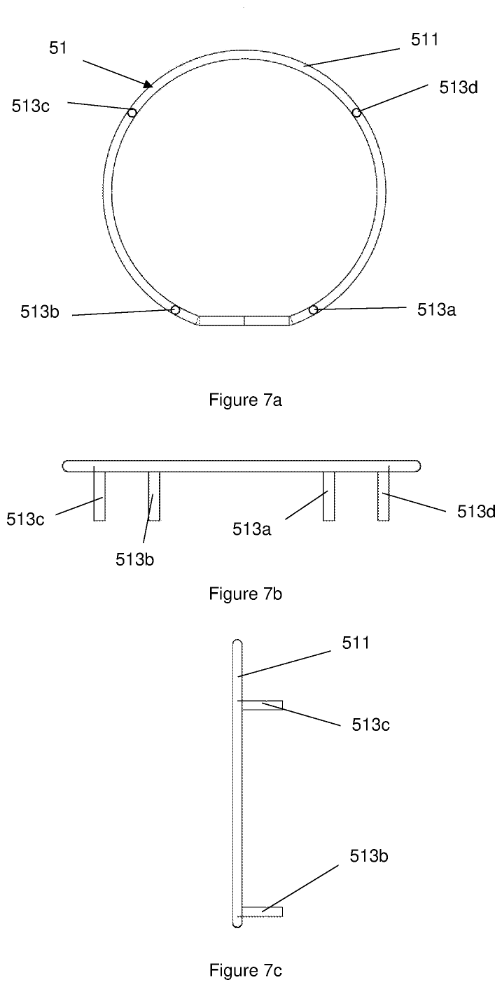

FIG. 7a ring 51 of the internal frame 5

FIG. 7b ring 51 layout

FIG. 7c side drawing of the ring 51

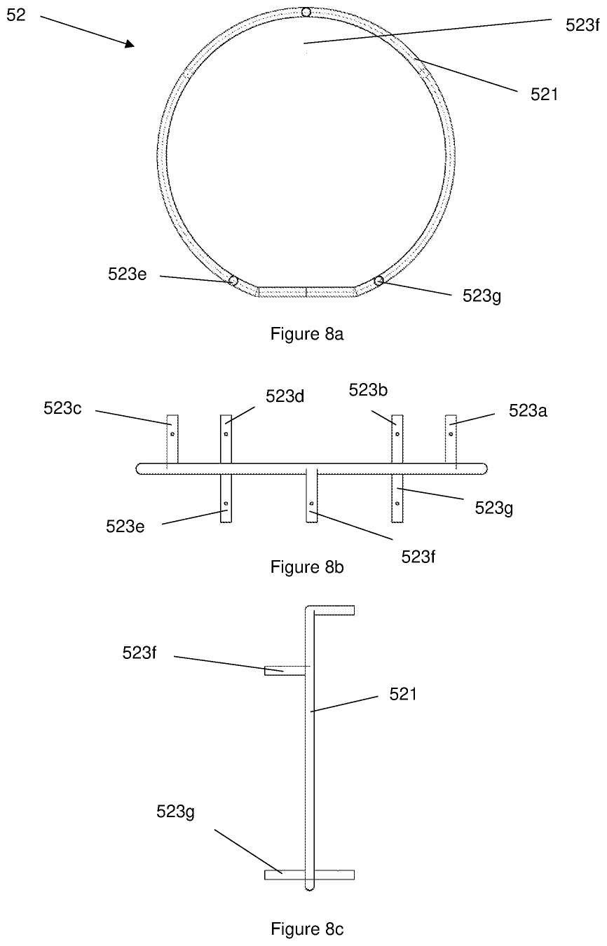

FIG. 8a ring 52 of the internal frame 5

FIG. 8b ring 52 layout

FIG. 8c side drawing of the ring 52

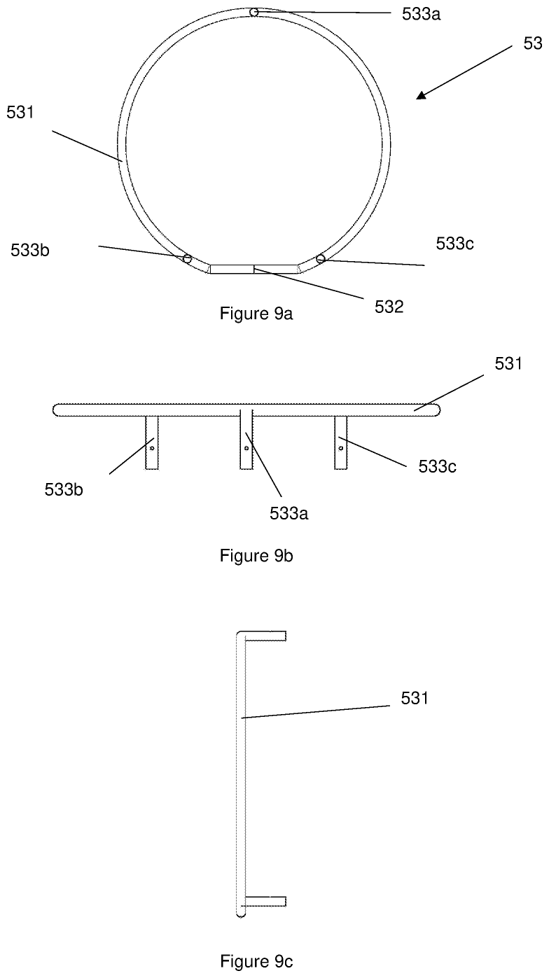

FIG. 9a second ring 53 of the internal frame 5

FIG. 9b second ring 53 layout

FIG. 9c side drawing of the second ring 53

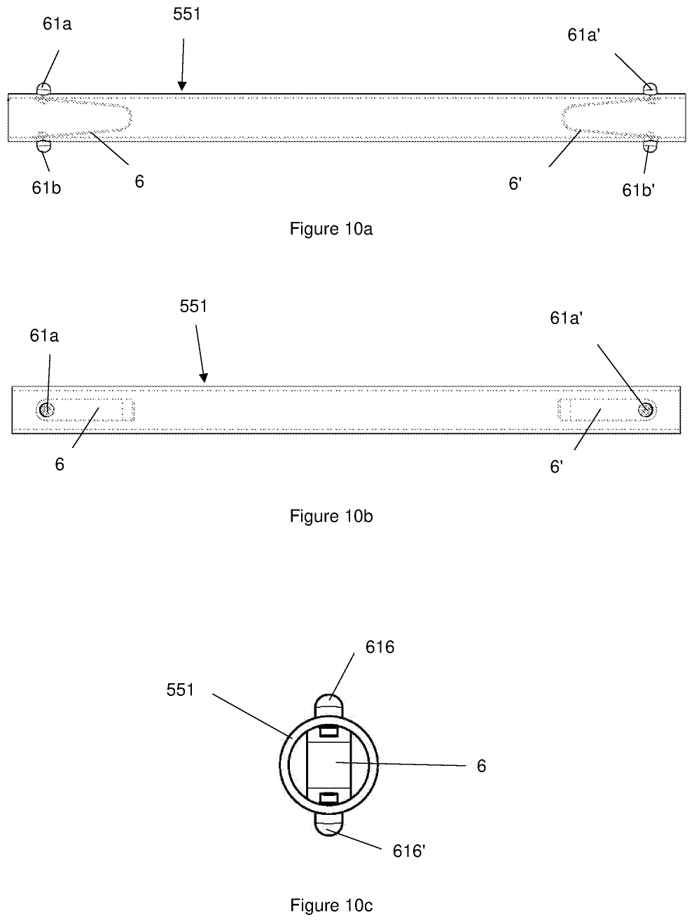

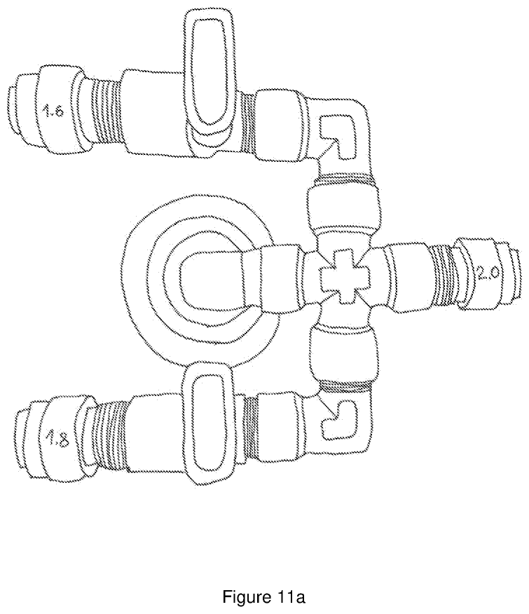

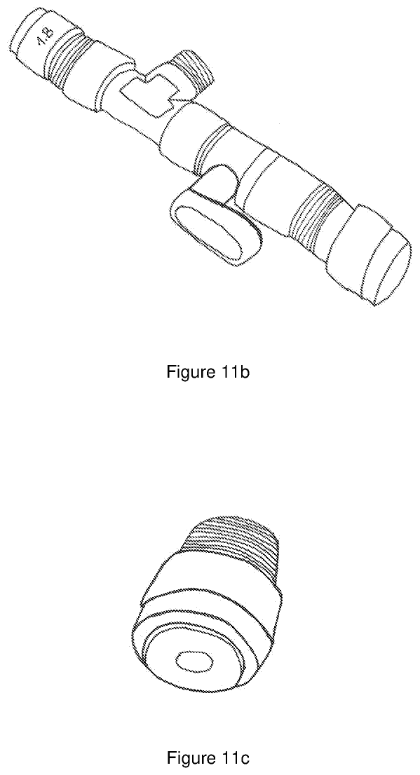

FIG. 10a longitudinal connection tube of the internal frame 5

FIG. 10b longitudinal connection tube of the internal frame 5 layout

FIG. 10c side drawing of the longitudinal connection tube of the internal frame 5

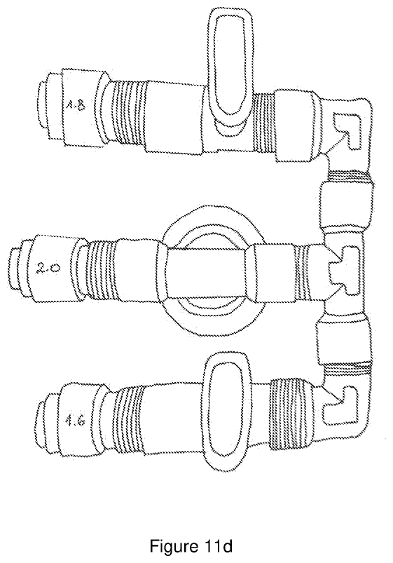

FIG. 11a set of three valves in the shape of a fork

FIG. 11b set of two valves in the shape of letter T

FIG. 11c single overpressure valve

FIG. 11d set of three valves in the shape of a mirror image capital letter E

As shown in FIG. 1 the inflatable hyperbaric chamber with the multilayer structure according to the invention is made so that the three-layer assembly of the chamber can lay directly on the ground or on a base 1, which has one or two supporting legs 11, preferably with a flat middle part and triangular supports on each side. Next to the supporting leg 11 an outer handle 12 may be attached, which can be moved towards the second supporting leg 11. The supporting legs may have any other shape with symmetrical outer parts. Into the inner part of the chamber a modular internal frame 5 is installed and this internal frame may receive a cushion 6 for comfortable lying. The three-layer structure of the chamber comprises a cylindrically shaped inner bag 4, which is placed into a cylindrically shaped outer bag 2, being surrounded with a grid 3 (see FIG. 2). The inner bag 4 has a zipper opening or any other longitudinal closure (flap) in the middle, while the outer bag 2 in the middle has an opening with an insert inserted into a tailored elongated flap on one or both sides of the opening. The adhesion of the inner bag 4 with the outer bag 2 is enabled with staples, with hooks and loops such as Velcro® tapes, wherein the first part of the tape with hooks is on the outer side of the inner bag 4 and the second part of the tape with loops is on the inner side of the outer bag 2. Said Velcro® tapes with hooks and loops may also be placed vice versa, so that the first part with loops is on the outer side of the inner bag and the second part with hooks is on the inner side of the outer bag 2. Operation of the hyperbaric chamber includes a powerful air compressor 7, that allows increasing of the pressure inside the chamber and suitable ventilation and the oxygen tanks or any other source of oxygen or concentrator.

The adhesion between the inner bag 4 and outer bag 2 can also be secured in other way, such as gluing, welding, any coupling or clamping system, or the inner bag 4 is not attached to the outer bag 2 at all.

The inner bag 4 comprises a base wrap 41 and a first circularly shaped bottom 42 and a second circularly shaped bottom 42′ (see FIG. 3). On the outer side and in the middle of the first bottom 42 an opening is provided, which is closed by a first soft window 42a, preferably welded or glued around the opening. The second bottom 42′ is manufactured in the same way as the first. The wrap 41 has in its middle an opening 411 for the zipper 44. Near the bottom 42′ and parallelly to the opening 411 there are two reinforcements 412 and 412′ with circular holes equipped with attachments 412a and 412a′ for installing valves or instruments. On the other side of the opening 411, close to the first bottom 42, there are triple reinforcements 413 and 413′ with three circular holes with attachments 413a and 413a′ for installing three pairs of valves or instruments. Attachments 412a, 412a′, 413a and 413a′ are equipped with inner threads. Between the reinforcement 413 and the edge of the bottom 42, there is a pair of rectangular openings 414 closed with a soft window 414a. On the other side, between the reinforcement 413′ and the edge of the bottom 42, there is a pair of rectangular openings 414′ closed with a soft window 414a′. The previously mentioned reinforcements may also be located elsewhere on the wrap 41.

As shown in FIG. 3a and FIG. 3c, the wrap 41 of the inner bag 4 is preferably welded or sewn along both parallel sides of the upper part 41a and bottom part 41b of the wrap, so that the sides are preferably welded or sewn along the connection 415 on one side and the connection 415′ on the other side. The wrap 41 of the inner bag 4 consists of the upper part 41a and the bottom part 41b. The upper part 41a and the bottom part 41b are preferably welded or sewn along the connection 415 and connection 415′ on the other side. The upper part 41a and the bottom part 41b can alternatively be glued along the connections 415 and 415′. Reinforcements 412′, triple reinforcements 413′ and two rectangular openings 414 are located above the connection 415. FIG. 3b shows a plan view of the inner bag 4, where the previously described locations of the opening 411, reinforcements 412, 412′, 413 and 413′ and openings 414 and 414′ are depicted. The zipper 44 is in the place of the opening 411, the edge 411a of the weld or stitching of the zipper and outer edge 411b of the weld or stitching of the zipper. FIG. 3c shows a side view of the inner bag 4 with the connection 415 and connection 415′ on the other side.

The first reinforcement 412 is rectangularly shaped with a circular hole with an attachment 412a in the middle. On one side of the opening with the attachment 412a strap 412b and a strap 412c on the other side are sewn on the reinforcement 412. Straps 412b and 412c are parts of the tape with hooks of the Velcro® straps. Around the opening with the attachment 412a preferably from the inner and the outer side of the reinforcement 412, a first pair of rings 412d is welded affixing the attachment 412a for a valve or instrument.

The second reinforcement 412′ is rectangularly shaped with a circular hole with an attachment 412a′ in the middle. On the reinforcement 412′ with the attachment 412a′, the tape 412b′ on one side of the opening and the tape 412c′ on the other side of the opening are sewn. Tapes 412b′ and 412c′ are tapes with hooks of the Velcro® tapes. Around the hole with the attachment 412a′ there is a second pair of rings 412d′ welded from the inner and the outer side of the reinforcement 412′ on the bag 4, affixing the attachment 412a′ for the valve or instrument. The first pair of rings 412a and the second pair of rings 412d′ in addition to affixing the attachments 412a and 412a′ serve as a reinforcement for the area around the holes with attachments 412a and 412a′.

The third reinforcement 413 is rectangularly shaped with three circular holes with attachments 413a. Four tapes 413b are sewn onto the reinforcement 413. These tapes 413b are tapes with hooks of the Velcro® tapes. Around the holes with the attachment 413a from the inner and the outer side of the reinforcement 413 on the bag 4, three pairs of third rings 413d are welded, affixing attachments for valves and instruments.

The fourth reinforcement 413′ is rectangularly shaped with three circular holes with attachments 413a′. Four tapes 413b′ are sewn onto the reinforcement 413′. Tapes 413b′ are tapes with hooks of the Velcro® tapes. Around the holes with the attachment 413a′ from the inner and the outer side of the reinforcement 413′ on the bag 4, three pairs of fourth rings 413d′ are welded, affixing attachments for valves and instruments.

The third pair of rings 412d and the fourth pair of rings 412d′ in addition to affixing attachments 413a and 413a′ serve as a reinforcement of the area around the holes with attachments 413a and 413a′.

Reinforcements with holes, into which attachments with inner or outer threads for mounting valves and instruments, may be located on the circumference 41 in a different manner, namely at any place on the upper part 41a of the wrap 41. The attachments for valves and instruments may be fixed with a pair of rings around the holes even without reinforcements.

Around the two rectangular openings 414 on the left upper part 41a of the wrap 41 the first soft window 414a is welded, preferably having an oval shape. Around two rectangular openings 414′ on the right upper part 41a of the wrap 41 the second preferably oval soft window 414a′ is welded. Soft windows 414a and 414a′ are preferably welded on the inner side of the bag 4, while they may also be welded on the outer side of the bag 4. Windows 414a and 414a′ may be rectangular, circular or any other shape.

Circumference of the wrap 41 is preferably sewn or can also be welded together with the first circularly shaped bottom 42 on one side and together with the second circularly shaped bottom 42′ on the other side of the wrap 41. The folds, which are intentionally created on both sides of the wrap 41, are folded onto the wrap 41 and are welded on the inner side of the thus created inner bag 4. In this manner stitches or welds are covered, which contributes to sealing of the connection. The inner folded fold may be additionally covered with a special covering seam tape for covering stitches or welds and reinforces as well as seals the inner bag.

As shown in FIG. 4a the wrap 21 of the outer bag 2 is preferably welded or sewn on the circumference of both parallel bottoms of the wrap. The wrap 21 of the outer bag 2 comprises an upper part 21a and a bottom part 21b. The upper part 21a and the bottom part 21b are preferably welded or sewn on the connection 215 and the connection 215′ on the other side. Above the connection 215, there are two reinforcements 212 and 212′, triple reinforcements 213 and 213′ and two rectangular openings 214 and 214′. FIG. 4b shows the plan view of the outer bag 2, wherein the elongated flap 24 is located on the inner side of the outer bag and above the zipper 44 of the inner bag 4. The flap 24 is sewn or preferably welded preferably on the right or optionally on the left side of the opening. There could be two flaps with open parts in the middle of the upper part of the wrap 21 a of the wrap 21. Reinforcements 212, 212′, 213 and 213′ and openings 214 and 214′ are located on the part 21a of the wrap 21.

The reinforcement of the opening 24 on the outer bag 2 is preferably welded or sewn or glued around the opening 24, to which two first parts of the Velcro® tape 24a and 24b with hooks are preferably sewn longitudinally. The tapes 24a and 24b may also be welded or glued and and serve as a gripper for mounting the grid 3, having other parts of the Velcro® tape with loops around the opening. This method of attaching the grid 3 to the outer bag 2 makes it possible to change the grid as the grid is detachable (removable).

The bonding of the chamber layers, preferably performed with Velcro® tapes or optionally with any other suitable releasable system, allows unlimited assembly and disassembly to the multilayer or single layer structure.

The elongated flap 24c is adapted for installation preferably two inserts located below the opening of the wrap 21, so that the opening is in the middle of the flap. FIG. 4c shows a side view of the outer bag 2 with connection 215 on one side and connection 215′ on the other side. Into the flap 24c at least one insert is inserted, preferably two to optionally five. The inserts are preferably made of plexi glass or plastics, but can be made of any other flexible or hard material.

The fifth reinforcement 212 is rectangularly shaped with a circular hole 212a in the middle. To the reinforcement 212 on one side of the hole 212a, the tape 212b is preferably sewn, while tape 212c is sewn on the other side. The Velcro® tapes 212b and 212c are tapes with loops and may also be welded or glued.

The sixth reinforcement 212′ is rectangularly shaped with a circular hole 212a′ in the middle. To the reinforcement 212′ on one side of the hole 212a′ the tape 212b′ is preferably sewn, while tape 212c′ is sewn on the other side. The Velcro® tapes 212b′ and 212c′ are tapes with loops and may also be welded or glued.

The seventh reinforcement 213 is rectangularly shaped with three circular holes 213a. Preferably four Velcro® tapes 213b are sewn onto the reinforcement 213. Said tapes with loops may be optionally welded or glued.

The eight reinforcement 213′ is rectangularly shaped with three circular holes 213a′. Preferably four Velcro® tapes 213b′ are sewn onto the reinforcement 213′. Said Velcro® tapes 213b′ with loops may be optionally welded or glued.

Around two rectangular openings 214 on the upper left part 21a of the wrap 21 a first holder 214a for the window is welded, into which the first preferably rectangular window 8 is mounted (FIG. 4g). Around the two rectangular openings 214′ on the upper right part 21a of the wrap 21, a second holder 214a′ is welded, into which the second preferably rectangular window 8′ is mounted. Windows 8 and 8′ are preferably rectangular, but can be of any shape. The holders 214a and 214a′ are welded on the inner side of the bag 2. The first holder 214a is approximately oval shape with two approximately rectangular openings 2141. Left of the openings 2141 there are bent tabs 2143a and 2143b which are at an angle to one another relative to the horizontal axis of the carrier 214. The angle is preferably 45°, but may be between 20° and 90°. On the bent tab 2143a tape 2143a′ with hooks is sewn and the other part of the tape 2143a″ with loops is sewn on a part of the holder 214a, located between the opening 2142 and it's nearest opening 2141. The tape 2143a is on the same axis as the tape 2143a″, so that the opening 2142 is closed after mounting the window 8 into the holder 214a. The holder 214a′ is made in the same way. Described constructional characteristics enable replacement of hard windows 8 and 8′ on the outer bag 2.

As shown in FIG. 4a and FIG. 4c the wrap 21 of the outer bag 2 is preferably welded or sewn along both parallel sides of the upper part 21a and the bottom part 21b of the wrap, so that the connection 215 and connection 215′ on the other side are created. The wrap 21 of the outer bag 2 comprises the upper part 21a and the bottom part 21b. The upper part 21a and the bottom part 21b are preferably welded or optionally sewn over joint 215 and joint 215′ on the other side. The upper part 21a and the bottom part 21b may be optionally glued over joint 215 and joint 215′ on the other side. Following the circumference of the wrap 21, a circular tab 221 is preferably welded, optionally sewn or glued and then further preferably welded, sewn or glued to the first bottom 22 having a circular hole 22a in the center. Around the hole 22a a third holder 222 is welded, with a circular hole in the middle and a notch 222a and bent tabs 222b and 222c (see FIGS. 4d, 4e and 4f). Bent tabs 222b and 222c are angled at each other relative to the center of the holder 222. The angle is preferably 45°, may be also between 20° in 90°. The bent tab 222b has a sewn tape 222b′ with hooks of the Velcro® tape, while the other part 222b′″ of Velcro with loops is sewn on the part of the holder 222, which is behind the hole 222a. The bent tab 222c has a sewn tape 222c′ with hooks, while the other tape 222c″ with loops is sewn on the part of the holder 222, which is behind the opening 222a. The tape 222b′ lays on the same axis as the tape 222b″, so that the opening 222a after installation of the circular window into the holder 222 is closed. On the other side of the wrap 21 along the circumference the bottom 22′ is sewn and welded, wherein this bottom is a mirror image of the bottom 22.

Once the inner bag 4 and the outer bag 2 are manufactured, the inner bag 4 is inserted into the outer bag 2 so that the wrap 41 is extended inside the wrap 21 of the outer bag 2, wherein the bottoms 42 and 42′ are in line with the bottoms of the outer bag 2. The first reinforcement 412 is connected to the tapes 212b and 212c of the fifth reinforcement 212 with tapes 412b and 412c. Tapes 412b and 412c are tapes with hooks, while tapes 212b and 212c are tapes with loops of the Velcro® tapes of the reinforcement 212.

The second reinforcement 412′ is fastened by the tape 412b′ and tape 412c′ by the tape 212b′ and tape 212c′ of the sixth reinforcement 212′. The tapes 412b′ and 412c′ are tapes with hooks fastened to the tapes 212b′ and 212c′ with loops of the Velcro® of the reinforcement 212′.

The third reinforcement 413 is using four tapes 413b fastened with four tapes 213b of the seventh reinforcement 213. The tapes 413b are tapes with hooks, while tapes 213b are tapes with loops of the Velcro® tapes of the seventh reinforcement 213.

The fourth reinforcement 413′ is using four tapes 413b′ fastened with four tapes 213b′ of the eighth reinforcement 213′. The tapes 413b′ are tapes with hooks, while tapes 213b′ are tapes with loops of the Velcro® tapes of reinforcement 213′.

All previously described welds are made with high frequency welding or hot air welding. In case of welding with overlapping edges, the tabs are not formed and their folding and covering with special covering seam tape is not needed.

The inner bag 4 ensures sealing, wherein the outer bag 2 enables additional protection of the inner bag 4 and holding the structure as well as relief of the inner bag 4. The inner bag 4 is made from the same of thinner and more flexible material as the material of the outer bag 2. The inner bag 4 is preferably slightly larger than the outer bag 2 due to expansion and adaptation to the shape of the outer bag; however, it can also have the same size as the outer bag.

The outer bag 2 is surrounded by the grid 3 (also called a net from straps or webbing), which for reasons of compactness, retains the shape of bag 4 and bag 2 and enables uniform distribution of forces, when the chamber is in operation. The grid 3 (see FIGS. 5 and 5a) is sewn from longitudinal straps 31, which are preferably uniformly distributed on the circumference 21 of the outer bag 2. The strap 31 is folded and sewn at both ends, so that a loop for installing into the rings 35 is created, the centres of the loops preferably being in the middle of the window opening installed on bottoms 21 and 21′. The ends of the 13 longitudinal straps 31 are on one side installed into the first ring 35, which is on the outer side of the bottom 21, and on the other side, they are installed into the second ring 35, which is on the outer side of the bottom 21′. From the first to the last transverse strap 32, on the spot for opening and zipper, tapes 34a and 34b are sewn to the wide parts of the tapes 34a and 34b with loops of Velcro® tapes. Tapes 34a and 34b may also be welded or glued. Perpendicularly to the longitudinal straps 31 preferably four straps 32 and 33 are sewn, terminated by buckle 33a and buckle 33b. Parts of straps 32 in 33 which overlap may be welded or glued. Straps 34a and 34b enable the grid 3 to be fixed in a position above the zipper opening 44 to the outer bag 2.

Straps 31 are preferably evenly spaced along the circumference of the outer bag 2. There are preferably three straps 32 on the side of bottom 21, wherein preferably one strap 32 is provided on the side of the bottom 21′. Between these straps eight straps 33 are preferred. The grid is preferably manufactured using an accessory, which has grooves for longitudinal straps 31, strap 34a, strap 34b and grooves for transversal straps 32 and 33. When the straps 31 together with strap 34a and strap 34b are mounted in the accessory, the parts to be covered with straps 32 and 33 are fixed to remain in place. Once the straps 32 and 33 are installed, the folded parts of straps are sewn or welded together with the folded parts of the straps 31, 34a and 34b. The straps 33 above the zipper 44 and the flaps are completed on one side with the first part of the buckle and on the other with the second part of the buckle. Said boucles are preferably clips, but can also be rings, but the straps on either side may be completed with a ring through which a steel round or flat bar is pushed. Prior to the air being released into the chamber, the buckle sections are clamped together so that each individual strap 33 creates a ring around the wrap 21 and the inner wrap 41 (see FIGS. 5 and 5a). The grid 3 may be dense or sparse, meaning it has more or less longitudinal and transverse straps. The longitudinal straps may be denser than the transverse straps and vice versa. Transverse straps may be denser than longitudinal straps. In the last two cases, the grids are not uniform.

The grid allows strong structure retention and force distribution in both bags. Preferably, the straps of the grid are arranged so that the horizontal and vertical straps are evenly spaced. Preferably, the straps of the grid are attached or sewn at all crossings, allowing correct distribution of forces. The spacing between the straps may also be such that the horizontal straps are close to each other than the transverse straps, or vice versa. The straps of the grid are attached or sewn only on some of the crossings, wherein these crossings have to be evenly spaced. This special arrangement of straps is not just for the appearance, it is primarily intended for the correct distribution of forces in both the bags and the grid, which allows operation of the chamber at higher pressure. Horizontally positioned straps are secured on both sides of the outer bag by the circular rings located around the opening for the small side windows, so the ring is larger than the opening. This ensures that the windows are relieved from the pressure, as the grid can support and relieve them. The circular rings are made of stainless steel and allow uniform distribution of forces on the longitudinal straps along the length of the chamber. In addition, the grid design ensures a characteristic appearance of the larger windows, as instead of large oval window they appear as two smaller rectangular windows. The closure of the transverse straps is enabled with buckles, which also allows the structure to become evenly loaded.

There is an internal frame 5 inside the chamber, preventing the chamber to collapse, when it is not pressurized. Thus, even the empty, pressureless chamber has the correct shape and there is enough space for someone to fit inside.

The internal frame 5 consists of three rings with fittings for transverse longer and shorter tubes. Transverse longer tubes are preferably two, being connected to a shorter tube. The inner and the end rings can only be connected to one longer tube or more than two. The ring 51 (see FIGS. 6a, 6b and 6c) has a circularly shaped arch 511having a horizontal crossbar 512 at the bottom. The ring 51 has in its upper part attachments 513a and 513c and in its bottom part attachments 513b and 513d. The attachments 513a, 513b, 513c and 513d are provided with circular holes, which are drilled perpendicularly to the floor when the ring 51 is placed into the bottom of the chamber (see FIGS. 7a, 7b and 7c).

The ring 52 (see FIGS. 8a, 8b and 8c) has a circularly shaped arch 521, having a horizontal crossbar composed of a part 522 and a part 522′ at the bottom. The ring 52 has in its upper part attachments 523a and 523c and in its bottom part attachments 523b and 523d. The attachments 523a, 523b, 523c and 523d have circular holes, which are drilled perpendicularly to the floor once the ring 521 is placed into the bottom of the chamber.

The ring 53 (see FIGS. 9a, 9b and 9c) has a circularly shaped arch 531, having a horizontal crossbar composed of a part 532 and a part 532′. The ring 53 has in its upper part an attachment 533a and in the bottom part attachments 533b and 533c. The attachments 533a, 533b, 533c and 533d have circular holes, which are drilled perpendicularly to the floor once the ring 531 is placed into the bottom of the chamber.

The internal frame 5 consists of the ring 51, connected to the ring 52 so that the attachment 513b is through two longer tubes 551 and 551′ connected to the attachment 523b of the ring 52. The attachment 513d is through two longer tubes 552 and 552′ connected to the attachment 523a, the attachment 513c is through two longer tubes 551 and 551′ connected to the attachment 523c. The attachment 513a of the ring 51 and the attachment 523a of the ring 52 are not connected, however the longer tubes 551 and 551′ could be transferred from the attachments 513b and 523b. The location of tubes 551 and 551′ depends on the user's wish where the entrance to the chamber should be located.

Rings 51, 52 and 53 connect shorter and longer tubes, which have at their ends inserted spring elements 6 in the shape of an elongated, flattened and horizontally placed letter V, which is on both open ends equipped with two plugs 61a and 61b (see FIGS. 10a, 10b and 10c). On the other side of the tube a mirror image of the spring element 6 is located, which is marked with reference 6′ and has plugs 61a′ and 61b′. The connection between ring attachments and/or connecting tubes is enabled with circular holes, with which the plugs interact due to pressure to the plugs (for example plugs 61a, 61b) which results in the tubes being moved so that the centres of holes and plugs are in the same line. Then the plugs are forced into the holes due to the spring element 6, thus creating a solid connection of both tubes. The connection may be decoupled in a simple manner, so that the plugs are pushed into the tube, which presses the open ends of the spring element 6 together and one tube may therefore be removed. The plugs are thereafter moved into their initial position, as the springs push those outwards. Because the spring element 6 is symmetrical, both plugs are movable inwards and outwards.

When the inner bag 4 is installed into the outer bag 2 and the grid 3 is placed on the outer bag 2 and the instruments, valves for oxygen and air supply, manometer and discharge valves are installed into the accessories with threads, the internal frame is optionally installed in the interior of the chamber as well as the pillow (also called bed or cushion).

Through the hole 212a in the reinforcement 212 and the attachment 412a in the reinforcement 412, the outer overpressure valve V1 is installed. Through the hole 212a′ in the reinforcement 212′ and the attachment 412a′ in the reinforcement 412′, a safety valve V2 is installed, allowing the release from the inner side and is intended as an emergency exit. To the left of the valve V2 a first outer release valve V6 is installed through the first hole 213a′ in the reinforcement 213′ and the first attachment 413a′ in the reinforcement 413′, while the second outer release valve V7 with a muffler facing downwards is installed through the second hole 213a′ in the reinforcement 213′ and the attachment 413a′ in the reinforcement 413′. Through the third hole 213a′ in the reinforcement 213′ and the third attachment 413a′ in the reinforcement 413′ a manometer M is installed. Left of the valve V1 through the first hole 213a in the reinforcement 213 and the first attachment 413a in the reinforcement 413 a valve V3 for air supply is installed, while through the second hole 213a in the reinforcement 213 and the second attachment 413a in the reinforcement 413 a valve V4 for oxygen supply is installed. Through the third hole 213a in the reinforcement 213 and the third attachment 413a in the reinforcement 413 a second overpressure valve V5 is installed. The valves V1, V2, V3, V4, V5 and D1, D2 as well as manometer M may be placed differently, depending on the use of the chamber.

Overpressure (pressure relief) valves V1 and V5 may be in three embodiments and are preferably in pairs. The first embodiment is a set of valves in the shape of a fork or a capital letter E, which allows the air to flow out of the chamber via three overpressure valves into the space outside the chamber (see FIG. 11a). Three overpressure valves with different pressure settings are coupled onto the fork, preferably 200 kPa as the highest, and 180 kPa and 160 kPa valves, which can be closed with two additional valves »open/close«. In case both valves »open/close« are closed only the highest valve 200 kPa will operate, with the other ones inactive. In case the »open/close« valve for 180 kPa is open, the 180 kPa valve will operate, the lower 160 kPa will be inactive, while the highest will not be activated. In case the »open/close« valve for 160 kPa is open, the 160 kPa valve will operate, while the others will not be activated and will remain closed and inactive. Thus, to the valves in the shape of a fork three overpressure valves with different pressure settings are coupled, wherein their value is arbitrary, such as 300 kPa, 200 kPa and 180 kPa or any other three different pressures.

FIG. 11d shows the shape of a set of three valves, which has three legs with installed valves for different pressures. The set of the valves is shaped as a mirror image of the capital letter E.

A second embodiment is a set of two valves in the shape of a letter T, which allows the air to flow out of the chamber via two overpressure valves into the space outside the chamber. Onto the T-part two overpressure valves are coupled, the valves having different settings of pressure, preferably 180 kPa and 160 kPa and one valve »open/close«. In case the »open/close« valve is closed, only the higher overpressure valve is operating, in this case 180 kPa, while the other is inactive. In case the valve »open/close« is open, only the lower valve, in this case 160 kPa, will operate, and the higher valve will be inactive due to too low activation pressure (see FIG. 11b).

A third embodiment is only one overpressure valve, which limits the pressure inside the chamber. The valve may be arbitrarily set to the highest possible value or to the pressure limit, preferably to 160 kPa or 180 kPa or 200 kPa or 300 kPa (see FIG. 11c).

The shape and the distribution of the valves may be any known to the skilled person in the art. The principle of use of three, two or single valves with different pressures, wherein the pressures may be any, is known. As already mentioned, the embodiment in the shape of a fork or the letter E has preferably three valves with three different pressure settings, wherein the T-shaped valve has only two valves with two different pressure settings. The pressures on the valves in shape of a fork, letter E, letter T and/or single or double valve may be different. The valves are preferably in pairs, but this is not necessary. Overpressure valves may be single valves.

The outer bag 2 provides protection of the inner bag 4 and holding the structure as well as relief of the inner bag 4. Opening of the outer bag 2 is reinforced with a flap, which is intended to cover the zipper and to safeguard it so that it does not open due to increased pressure inside the chamber. When the chamber is in use, strong forces act on the zipper due to increasing pressure, while the flap relieves the zipper by decreasing the pressure. The flap is preferably made as a shorter insert, into which a plexi insert is inserted. The flap is then closed using pre-sewn Velcro® strap. Into the longer part of the flap a longer plexi insert is inserted, so that it partly covers a part of the shorter insert. Then, the longer insert is also closed with the pre-sewn Velcro® straps. This ensures safe placement of the flap and reliable closure of the zipper. The flap may be made as one single long insert or as more overlapping inserts. The inserts (reinforcements) may also be achieved by inserting a hard material into the flaps or the hard material is attached to the wrap of the outer bag 2 with a special covering technique. The flap may be sewn or welded to the outer bag and is attached to the inner side below the opening.

The flap may have one inserts on any side or two inserts, each located on each side. The reinforcement prevents unwanted expanding of the opening with the zipper when the chamber is operating. Without this, the zipper would not withstand such pressures. Side walls of the outer bag are designed and built in in a special way. The windows are easily replaceable as they have covers where they can be inserted and fixed with Velcro® straps (loops and hooks). The material of the outer bag 2 should be thicker or at least the same as, but most often less flexible than the material for the inner bag 4.

The structure and characteristic connections of the individual functional elements of the inflatable hyperbaric chamber according to the invention enables operation under pressures of 130 kPa (1.3 bar) to 300 kPa (3.0 bar). Due to the sewing of sides of the wraps and bottoms and welding of the previously sewn connections, and due to the multilayer structure and the design of the grid, the effect of the high pressure inside the chamber is minimal since the constructional design of the chamber allows uniform distribution of the forces on all parts of the chamber.

The inflatable hyperbaric chamber is made of antioxidant materials that do not lose quality despite the increased oxygen concentration. The chamber operating pressure is preferably 200 kPa (2,0 bar), but may be between 130 kPa (1.3 bar) and 300 kPa (3.0 bar). Such high pressure enables an effective system of closing with the help of a special zipper on the inner bag, the flap with the insert on the outer bag for covering the zipper, the grid with straps provided with stainless steel or any other buckles, which additionally press the flap on the zipper. The chamber consists of three layers, an inner and an outer bag, surrounded by a grid. The inner bag is intended for sealing, while the outer bag protects the inner bag and maintains the shape of the whole chamber. Both bags are connected with the special system of valves and instruments for controlled pressure management. All materials are suitable for work with pure oxygen. The internal frame inside the chamber prevents the chamber from collapsing, so that even an empty chamber without increased pressure can retain the correct shape and allows comfortable space for a user. The chamber is driven by the compressor, which allows the chamber to be pressurized and properly ventilated. The compressor is continuously switched on throughout the therapy, as it provides for the ventilation of the chamber.

Oxygen supply is provided by oxygen concentrators, which by means of special filters, separates pure oxygen from the air with 93±3% purity using PSA technology. The oxygen concentrators enable continuous oxygen supply even at the highest possible pressure. Although the user breathes pure oxygen in the chamber, the oxygen concentration inside the chamber never exceeds 30% due to aeration. Oxygen supply may be provided from a different source, as the chamber has a valve allowing connection of an additional oxygen source.

The inflatable hyperbaric chamber with the multilayer structure is designed so that the inner bag houses a foldable internal frame, wherein the inner cylindrically shaped bag is installed into the outer cylindrically shaped bag surrounded with the grid. The inner as well as the outer bag have an opening in their middle, wherein the inner bag is closed with the zipper, while the outer bag has a system of flaps, into which one or two polycarbonate inserts are installed to relief the zipper when the chamber is operating. The inserts may be made of any other flexible material such as acrylic glass or plastics.

When in use, the entire chamber stands horizontally on the ground. An external handle (handrail) is designed to easier entry into and exit from the chamber. The chamber may not have the handle or may have two handles as shown in FIG. 1. The handle consists of a flat base and a semi-circular shaped upper part designed to grip by the user.

1. An inflatable hyperbaric chamber with a multi-layer structure, which comprises a powerful compressor for raising pressure inside the chamber and proper ventilation, and an oxygen tank or any other oxygen source or a concentrator, characterized in that:
the chamber has a three-layered structure and a releasable connection of individual layers and functional elements, which allows operation of the chamber at pressures from 130 kPa (1.3 bar) to 300 kPa (3.0 bar), wherein the three-layered structure consists of an inner bag, an outer bag and a grid, mutually connected with straps with hooks on one layer interacting with straps with loops on another layer;
soft windows are provided on a wrap of the inner bag;
hard windows are provided on a wrap of the outer bag;
a zipper on the inner bag for closing thereof is covered with a flap containing the inserts;
above the flap trasverse straps of the grid are closed with buckles;
rings are installed on the bottoms, wherein ends of horizontal straps of the grid are trapped in the said rings;
the outer bag has holes corresponding to circular holes of the inner bag, the circular coles having attachments for mounting a system of valves and instruments for controlling the pressure inside the chamber.

2. The inflatable hyperbaric chamber according to claim 1, characterized in that the inner bag (4) consists of a base wrap (41) and a first circularly shaped bottom (42) and a second circularly shaped bottom (42′); that on the outer side and in the middle of the first bottom (42) an opening is provided, the opening being closed by a first soft window (42a), and that on the other side and in the middle of the second bottom (42′) a second opening is provided, the second opening being closed by a second soft window; that the wrap (41) has in its middle an opening (411) for the zipper (44); that circular holes with attachments (412a, 412a′, 413a in 413a′) with inner threads are provided anywhere on the wrap (41) for installation of valves or instruments; that between a reinforcement (413) and the edge of the bottom (42) a pair of rectangular openings (414) is provided, said openings being closed by a soft window (414a); that between a second reinforcement (413′) and the edge of the bottom (42) a second pair of rectangular openings (414′) is provided, said openings being closed by a second soft window (414a′).

3. The inflatable hyperbaric chamber according to claim 1 or claim 2, characterized in that connections of an upper part (41a) and a bottom part (41b) of the base wrap (41) and the first circularly shaped bottom (42) and the second circularly shaped bottom (42′) are preferably welded, sewn or glued.

4. The inflatable hyperbaric chamber according to any of the preceding claims, characterized in that the soft windows on the inner bag are preferably welded or glued around openings (214); that the first soft window on the bottom (42) and the second soft window on the second bottom (42′) are preferably welded or glued.

5. The inflatable hyperbaric chamber according to any of the preceding claims, characterized in that a wrap (21) of the outer bag (2) consists of an upper part (21a) and a bottom part (21b); that reinforcements (212 and 212′), triple reinforcements (213 and 213′) and two rectangular openings (214 and 214′) are located above a connection (215); an elongated flap (24) is located on the inner side of the outer bag and above the zipper (44) of the inner bag (4); the flap (24) is welded preferably right or optionally left of the opening; the flap (24) may be sewn or glued; that the flaps are made so that they have open parts in the middle of the upper part (21a) of the wrap (21); that reinforcements (212, 212′, 213 and 213′) and openings (214 and 214′) are located on part (21a) of the wrap (21).

6. The inflatable hyperbaric chamber according to claim 5, characterized in that the upper part (21a) and the bottom part (21b) of the wrap (21) are preferably welded or sewn on the connection (215) and a second connection (215′) on the other side; and that the flap (24) is preferably welded, sewn or glued.

7. The inflatable hyperbaric chamber according to any of the preceding claims, characterized in that after manufacture of the inner bag (4) and the outer bag (2), the inner bag (4) is inserted into the outer bag (2) so that the wrap (41) is expanded inside the wrap (21) of the outer bag (2), wherein the bottoms (42 and 42′) are aligned with the bottoms of the outer bag (2); that the first reinforcement (412) is with straps (412b and 412c) connected to straps (212b and 212c) of the fifth reinforcement (212); that the straps (412b and 412c) are straps with hooks interacting with straps (212b and 212c) with loops on the reinforcement (212).

8. The inflatable hyperbaric chamber according to claim 7, characterized in that straps (412b and 412c) are provided with loops and are connected to straps (212b and 212c) with hooks of the connective reinforcement strap (212).

9. The inflatable hyperbaric chamber according to any of the preceding claims, characterized in that circular holes (212a, 212a′, 213a and 213a′) are provided anywhere on the base wrap (21a) of the outer bag (2), wherein said holes correspond to the circular holes with attachments (412a, 412a′, 413a and 413a′) on the base wrap (41a) of the inner bag (4).

10. The inflatable hyperbaric chamber according to claim 9, characterized in that folds intentionally formed on both sides of the wrap (41) are folded on the wrap (41) and welded on the inner side of the so formed inner bag (4); that this results in coverage of stitching or welds for additional sealing of the connection.

11. The inflatable hyperbaric chamber according to claim 9 or claim 10, characterized in that the inner folded fold is additionally covered with a covering seam tape, which covers the stitching or welds and reinforces as well as seals the inner bag (4).

12. The inflatable hyperbaric chamber according to any of the preceding claims, characterized in that a first soft window (414a) is welded around two rectangular openings (414) on the left upper part (41a) of the wrap (41), said window preferably having an oval shape; that a second soft window (414a′) is welded around rectangular openings (414′) on the right upper part (41a) of the wrap (41), the said window preferably having an oval shape.

13. The inflatable hyperbaric chamber according to claim 12, characterized in that soft windows (414a and 414a′) are welded preferably on the inner side of the bag (4), but can be welded also to the outer side of the bag (4).

14. The inflatable hyperbaric chamber according to any of the preceding claims, characterized in that the windows (414a in 4140 may have circular, rectangular or any other shape.

15. The inflatable hyperbaric chamber according to any of the preceding claims, characterized in that reinforcement of the opening (24) on the outer bag (2) is preferably welded or sewn or glued around the opening (24), to which straps (24a and 24b) with hooks is sewn, welded or glued longitudinally and serve as an attachment for placing the grid (3), which is provided with straps with loops placed around the opening.

16. The inflatable hyperbaric chamber according to any of the preceding claims, characterized in that the grid (3) is sewn from longitudinal straps (31), which are preferably evenly distributed along the circumference of the wrap (21) of the outer bag (2); that the strap (31) is on both ends folded and sewn so that a loop is created for installation of a ring (35), of which centres are located approximately in the middle of the openings for windows mounted on the bottoms (21 and 21′); that ends of longitudinal straps (31) are on one side installed in the first ring (35), which is on the outer side of the bottom (21), and on the other side installed into the second ring (35), which is on the outer side of the second bottom (21′); that from the first to the last trasverse strap (32) on the area for the opening and zipper two straps (34a and 34b) with loops are sewn; that perpendicularly to the longitudinal straps (31) preferably four straps (32 and 33) are sewn, each of the latter straps ending with a buckle (33a and 33b); that parts of the straps (32 and 33), which overlap with straps (31), are preferably sewn; that straps (34a and 34b) enable attachment of the grid (3) on the place above the opening for the zipper (44) on the outer bag (2).

17. The inflatable hyperbaric chamber according to claim 16, characterized in that the tapes (34a and 34b) may be welded or glued; that parts of the straps (32 and 33), which overlap with parts of straps (31) may also be welded or glued.

18. The inflatable hyperbaric chamber according to any of the preceding claims, characterized in that the shape and distribution of valves may be any known in the field; and that pressures may be differently set, preferably between 200 kPa, 180 kPa and 160 kPa.

19. The inflatable hyperbaric chamber according to any of the preceding claims, characterized in that through the hole (212a) in the reinforcement (212) and attachment (412a) in the reinforcement an outer overpressure valve (V1) is installed; that through the hole (212a′) in the reinforcement (212′) and attachment (412a′) in the reinforcement (412′) a safety valve (V2) is installed for allowing air removal from the inner side and thus represents an emergency exit; that left of the valve (V2) through the first hole (213a′) in the reinforcement (213′) and first attachment (413a′) in the reinforcement (413′) a first outer release valve (V6) is installed, while through the second hole (213a′) in the reinforcement (213′) and second attachment (4130 in the reinforcement (413′) a second outer release valve (V7) with a muffler facing downwards is installed, and through the third hole (213a′) in the reinforcement (213′) and the third attachment (413a′) in the reinforcement (413′) a manometer (M) is installed; that left of the valve (V1) through the first hole (213a) in the reinforcement (213) and the first attachment (413a) in the reinforcement (413) an oxygen supply valve (V3) is installed, while through the second hole (213a) in the reinforcement (213) and the second attachment (413a) in the reinforcement (413) a second oxygen supply valve (V4) is installed and through the third hole (213a) in the reinforcement (213) and the third attachment (413a) in the reinforcement (413) a second overpressure valve (V5) is installed.

20. The inflatable hyperbaric chamber according to claim 18, characterized in that valves (V1, V2, V3, V4, V5, V6 and V7) and the manometer (M) may be mounted on other locations depending on the use of the chamber.

21. The inflatable hyperbaric chamber according to claim 18 or claim 19, characterized in that overpressure valves (V1 and V5) are preferably in pair and can be in the shape of a fork or the letter E, the valves allowing removal of air from the chamber into the space outside the chamber via three overpressure valves; that to the fork- or E-shaped valve three differently set overpressure valves are installed, preferably one is set to 200 kPa as the highest, the other two set to 180 kPa and 160 kPa, respectively, the latter valves could be closed with two valves »open/close«; that in case both valves »open/close« are closed, the highest valve 200 kPa is in operative state and the other two are inactive; that in case the valve »open/close« for the 180 kPa valve is open, the 180 kPa valve is in operative state, while the 160 kPa is inactive and 200 kPa valve is not activated due to too low activation pressure; that in case the valve »open/close« for the 160 kPa valve is open, the lowest valve 160 kPa is in operative state, while the other two valves are not activated due to too low activation pressure.

22. The inflatable hyperbaric chamber according to claim 18, characterized in that the set of valves is in the shape of the letter T, which allows removal of air from the chamber via two overpressure valves into the space outside the chamber; that to the T-valve two overpressure valves 180 kPa and 160 kPa and one »open/close« valve are installed; in case »open/close« valve is closed, the highest valve is in operative state, while the lower valve is closed and inactive through the »open/close« valve; that in case the »open/close« valve is open, the lower valve is in operative state, while the higher is inactive due to too low activation pressure.

23. The inflatable chamber according to claim 18 or claim 19, characterized in that into the attachments for valves and instruments only one overpressure valve is installed, the said overpressure valve limiting the pressure inside the chamber to different pressure settings, preferably to 160 kPa or 180 kPa or 200 kPa.

24. The inflatable hyperbaric chamber according to any of the preceding claims, characterized in that the internal frame (5) consists of three rings with attachments for transverse longer and shorter tubes; that the tranverse longer tubes are preferably two, wherein they may be connected with a shorter tube; that the inner ring (52) and the end ring (51) are connected with at least one longer tube or more;
that individual rings (51, 52 and 53) are releasably coupled into a whole with a smaller (541) and a longer tube (551), which are provided on its ends spring elements (6) in the shape of an elongated, flat, horizontally laid letter V, which is on both open ends equipped with two plugs (61a and 61b); that on the other side of the tube is a second spring element (6′) with plugs (61a′ in 61b′) is provided; that connections between attachments of the rings and/or connective tubes are enabled with circular holes on the rings (51, 52 and 53), into which plugs (61a, 61b) and/or plugs (61a′ in 61b′) can be pushed to the position where middle points of the holes and the plugs are in the same line; the plugs are thus due to the force of the spring element (6) arranged to be pushed throught the holes allowing a reliable connection of two tubes.

25. The inflatable hyperbaric chamber according to any of the preceding claims, characterized in that it is made of antioxidant materials that do not lose quality despite the increased concentration of oxygen and are suitable for working with oxygen.

26. The inflatable hyperbaric chamber according to any of the preceding claims, characterized in that the outer bag (2) has a system of flaps, into which one or two polycarbonate inserts are inserted; said inserts may be made of any other flexible material such as acrylic glass and/or plastics.
